(19) United States
(12) Patent Application Publication
(10) Pub. No.: US 2010/0019058 A1
(43) Pub. Date: Jan. 28, 2010

(54) NOZZLE ASSEMBLY FOR COLD GAS DYNAMIC SPRAY SYSTEM

(76) Inventors: Daniel P. Vanderzwet, Omemee (CA); Bertrand Jodoin, Ottawa (CA)

Correspondence Address: CARLSON, GASKEY & OLDS, P.C., 400 WEST MAPLE ROAD, SUITE 350, BIRMINGHAM, MI, 48009, US

(21) Appl. No.: 12/441,185

(22) PCT Filed: Sep. 13, 2006
(86) PCT No.: PCT/CA2006/001504

§ 371 Date: Mar. 13, 2009

(51) Int. Cl. F23D 11/16; B05B 1/00; B05B 17/00

(52) U.S. Cl. 239/9; 239/422; 239/591

(57) ABSTRACT

A cold gas dynamic spray system is provided that includes a powder feeder for providing a metallic powder. A carrier gas source provides a carrier gas. A nozzle assembly includes multiple plates secured to one another. One of the plates provides a nozzle profile, such as a venturi, having a gas carrier inlet receiving the carrier gas. The nozzle profile also provides a powder injection region receiving the metallic powder In one example, a profile plate includes an aperture providing the venturi. The venturi includes converging and diverging portions joined by a throat. The carrier gas inlet is in communication with the converging portion upstream from the throat. The powder injection region is in communication with the diverging section downstream from the throat. The profile plate includes an end from which the intermixed metallic powder and carrier gas exit the nozzle assembly. The aperture includes walls defining an increasing width extending axially from a location where the powder is introduced to the carrier gas to the end for providing generally laminar flow of the intermixed carrier gas and metallic powder. One or more profile plates can be selected based upon desired spray parameters and assembled to provide the nozzle assembly. Different substances may be provided to each nozzle profile, if desired. The nozzle profile geometry can be selected to achieve a desired spray parameter for depositing the metallic powder onto the substrate.

### BACKGROUND OF THE INVENTION

This invention relates to a nozzle assembly suitable for use in a cold gas dynamic spray system.

Cold gas dynamic spray systems are used to deposit a powder, typically a metallic material, onto a substrate, which is also typically metallic. A carrier gas and the metallic powder flow through a nozzle. The carrier gas intermingles with the powder and accelerates it to a desired velocity to adhere the powder to the substrate. Many different configurations of cold gas dynamic spray systems exist.

The nozzles are typically provided by a tubular member defining a venturi. The tubular member has internal frustoconical walls that define the venturi. The walls are subject to wear from the abrasive metallic powder that flows through venturi at high velocities. Machining the internal features of the venturi may be difficult. Further, it is difficult to access internal nozzle features during maintenance or to apply any wear resistant coatings. Moreover, prior art nozzles do not provide desired flexibility for depositing different powders or changing parameters affecting the deposit of the powder onto the substrate. Another problem with typical nozzles is that they only deposit material on a very small area of the substrate. As a result, many passes over the substrate are required to cover a desired area.

The substrate area to which the material is deposited must be cleaned or abraded so that they material will adhere to the area. Typically, a separate device is used to spray abrasive media at the area in preparation for depositing the powder onto the area, which increases the time required for the process. What is needed is a nozzle assembly that offers a more accessible and flexible design and that enables the material to be deposited onto the substrate more rapidly.

### SUMMARY OF THE INVENTION

A cold gas dynamic spray system is provided that includes a powder feeder for providing a metallic powder. A carrier gas source provides a carrier gas. A nozzle assembly includes multiple plates secured to one another. One of the plates provides a nozzle profile, such as a venturi, having a gas carrier inlet receiving the carrier gas. The nozzle profile also provides a powder injection region receiving the metallic powder. In one example, a profile plate includes an aperture providing the venturi. The venturi includes converging and diverging portions joined by a throat. The carrier gas inlet is in communication with the converging portion upstream from the throat. The powder injection region is in communication with the diverging section downstream from the throat. The profile plate includes an end from which the intermixed metallic powder and carrier gas exit the nozzle assembly. The aperture includes walls defining an increasing width extending axially from a location where the powder is introduced to the carrier gas to the end for providing generally laminar flow of the intermixed carrier gas and metallic powder.

One or more profile plates can be selected based upon desired spray parameters and assembled to provide the nozzle assembly. Abrasive media can be flowed through one of the profile plates to abrade the material before powder from another profile plate is deposited onto the substrate, for example. The nozzle profile geometry can be selected to achieve a desired spray parameter for depositing the metallic powder onto the substrate. A wider spray pattern can be achieved with the disclosed nozzle assembly compared to a prior art nozzle of the same size. More than one nozzle profile can be provided on a single profile plate. Different materials may be provided to each nozzle profile or profile plate, if desired.

Although a preferred embodiment of this invention has been disclosed, a worker of ordinary skill in this art would recognize that certain modifications would come within the scope of this invention. For that reason, the following claims should be studied to determine the true scope and content of this invention.

### BRIEF DESCRIPTION OF THE DRAWINGS

FIG. 1 is a schematic view of an example cold gas dynamic spray system.

FIG. 2a is an exploded perspective view of one example nozzle assembly.

FIG. 2b is a top-elevational view of the nozzle assembly shown in FIG. 2a.

FIG. 2c is an end-elevational view of the nozzle assembly shown in FIG. 2a.

FIG. 2d is a side-elevational view of the nozzle assembly shown in FIG. 2a.

FIG. 3 is a top-elevational view of a profile plate illustrating various features of an example nozzle profile.

FIG. 4a is an exploded perspective view of another example nozzle assembly.

FIG. 4b is an end-elevational view of the nozzle assembly shown in FIG. 4a.

FIG. 5 is a top-elevational view of another example profile plate.

FIG. 6 is a top-elevational view of yet another example profile plate.

### DETAILED DESCRIPTION OF THE PREFERRED EMBODIMENT

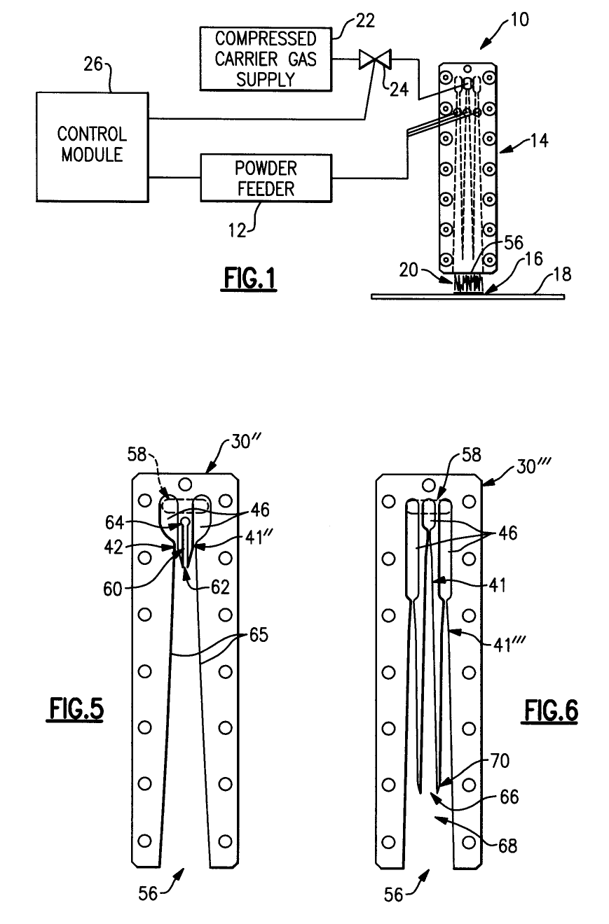

An example cold gas dynamic system 10 is shown schematically in FIG. 1. The system 10 includes a powder feeder 12 that provides a metallic powder, for example, to a nozzle assembly 14. The nozzle assembly 14 expels a spray 20 to deposit material 16 onto a substrate 18 such that the powder is adhered to the substrate 18. Other material may be expelled through the disclosed nozzle assembly 14, as discussed below. A compressed carrier gas 22 is regulated using a valve 24 and controller 26 to provide a desired gas pressure to the nozzle assembly 14. The nozzle assembly 14 includes a venturi or de Laval orifice for accelerating the metallic powder with the carrier gas to deposit the powder onto the substrate 18 at a desired velocity. The carrier gas velocity can be subsonic, supersonic or hypersonic. The schematically illustrated system 10 is only exemplary. The carrier gas and powder can be delivered to the nozzle assembly 14 in any suitable manner.

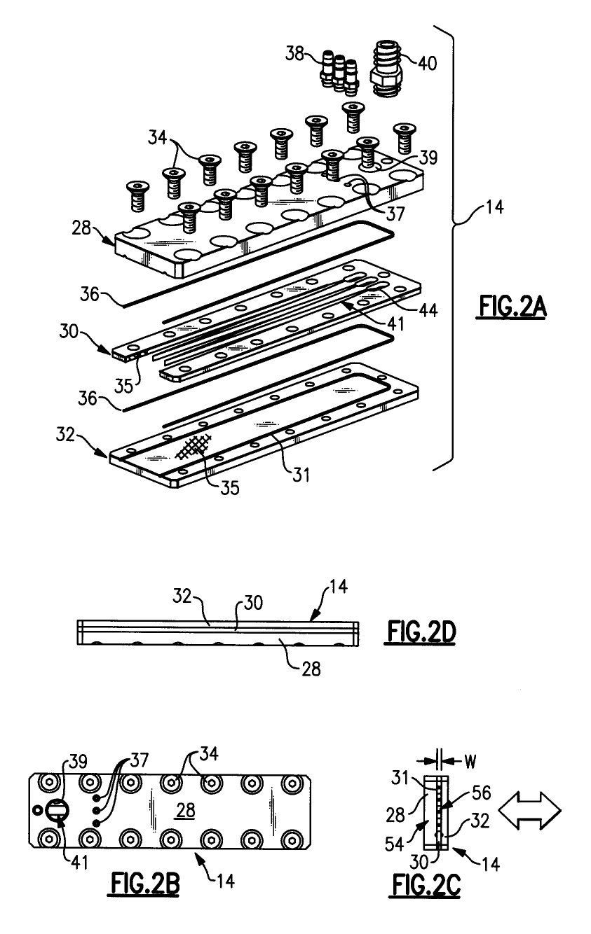

Referring to FIGS. 2a-2d, an example nozzle assembly 14 is shown. The nozzle assembly 14 includes a profile plate 30 arranged between a top plate 28 and bottom plate 32. The plates 28, 30, 32 are secured by threaded fasteners 34 in the example shown. The plates 28, 30, 32 can be secured in any suitable manner, for example, by brazing, heat resistive liquid gasket, sliding keepers, hinges or clamps. In the example shown, the plates 28, 30, 32 are sealed relative to one another using a gasket 36, which can be an annealed copper wire. In the example shown, the top and bottom plates 28, 32 include grooves 31 for receiving the gasket 36. In the example, the plates 28, 30, 32 can be disassembled to change out plates or unclog the nozzle assembly 14.

The plates 28, 30, 32 can be constructed from stock sizes of tool steel or other hardened materials such as carbides or ceramics. Economical manufacturing techniques can be employed such as 2-D milling, profile grinding, laser cutting, waterjet cutting, plasma cutting, fine blanking or EDM. The plates 28, 30, 32 can also be cooled or finned for heat removal during use.

The profile plate 30 provides a desired nozzle profile 41, which is a venturi in the example shown. The nozzle profile 41 includes an orifice or throat 42 causing a differential pressure across the throat 42, which accelerates the powder.

One or more of the plates 28, 30, 32 can include coatings 35 for decreasing the friction coefficient of the surfaces and/or for increasing the surface hardness to reduce plate wear. A sacrificial barrier could be arranged between the plates 28, 30, 32. Additionally or alternatively, the plates 28, 30, 32 can be constructed from different materials depending upon the friction and wear properties desired. For example, coating such as titanium nitride, diamond-like coatings, or ceramic coatins can be applied to various surfaces using any suitable method. Also, one or more of the plates 28, 30, 32 can be heat treated to obtain desired properties.

In the example, the top plate 28 includes powder inlet holes 37 receiving powder inlet fittings 38 that are in communication with the powder feeder 12. The top plate 28 also includes a carrier gas hole 39 receiving a carrier gas inlet fitting 40 that is in communication with the compressed carrier gas supply 22.

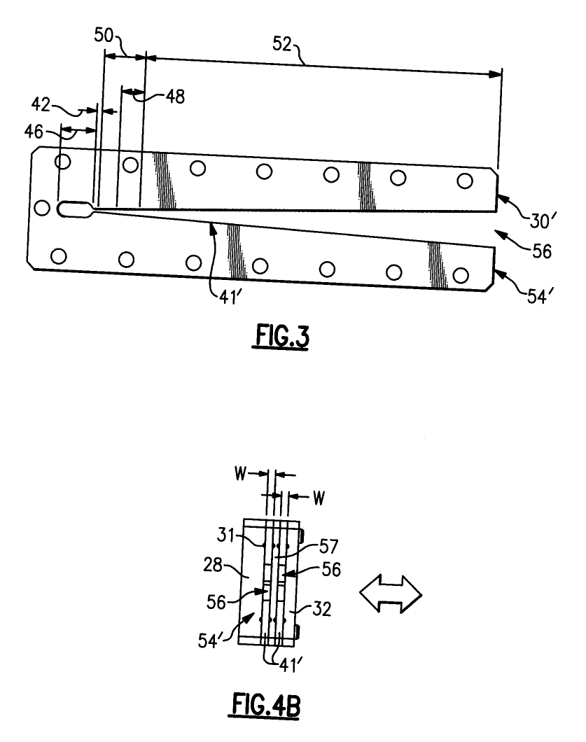

Referring to FIG. 3, the nozzle profile 41 includes a carrier gas inlet 46 that is provided by a converging portion in the example venturi. The converging portion tapers to the throat 42, which expands to provide a diverging portion. In the example shown, a powder injection region 48 is in communication with the diverging portion for receiving the powder from the powder feeder 12 through a powder inlet hole. The diverging portion includes a primary gas expansion area 50, which includes the powder injection region 48 in the example, and a secondary gas expansion area 52. The secondary gas expansion area 52 terminates in an opening 56 at an end 54 of the nozzle assembly 14.

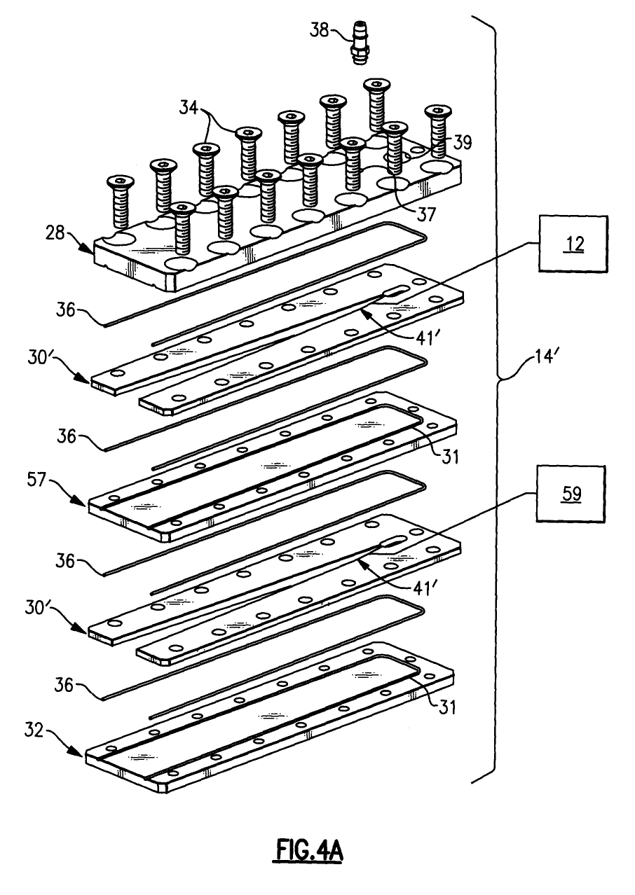

FIG. 2c illustrates a nozzle assembly 14 that sprays the powder at a width W. FIG. 4a-4b illustrates a nozzle assembly 14′ capable of spraying powder at a width, twice as wide as the individual width W, which is achieved by using multiple profile plates. It is desirable to expel the material in a direction perpendicular to the major dimension of the opening 56, which results in a larger deposition of material for a given pass over the substrate 18. That is, the nozzle assemblies 14, 14′ are moved laterally (in the direction of the large arrow) relative to the substrate to deposit the material.

The nozzle assembly 14′ utilizes multiple profile plates 30′ each of which can receive different substances, if desired. The same materials can be provided by more than one profile plate to increase the deposition rate, for example. An intermediate plate 57 separates the profile plates 30′. FIG. 4a illustrates the powder feeder 12 in communication with one of the profile plates 30′. A second source 59 is shown schematically in communication with the other profile plate 30′. The second source 59 may provide powder that is the same powder provided by the powder feeder 12. Alternatively, the second source 59 can provide a different powder or a gas, for example.

Stacking the profile plates within a nozzle assembly enables more flexibility. For example, different profile plates with different nozzle profiles can be used within the same nozzle assembly. Different substances may be introduced into the profile plates. For example, one profile plate may provide a continuous supply of powdered aluminum while the other profile plate may intermittently supply powdered copper. In another example, one profile plate may provide powder and the other profile plate may provide a heated gas. A nozzle assembly can be then be used in a manner such that the heated gas preheats the substrate prior to deposition of the powder from the other profile plate. In yet another example, one profile plate may be used to provide an abrasive. The profile plate providing the abrasive is oriented such that the abrasive cleans the substrate prior to deposition of the powder onto the substrate. Abrasives may include ceramics, polymers, carbon based materials or a combination thereof.

Several example nozzle profiles are illustrated. The example profile plate shown in FIGS. 3 and 4a illustrate a simple, single venturi provided by nozzle profile 41′. The example profile plates illustrated in FIGS. 1 and 2a illustrate multiple venturis within the same profile plate. The same substance may be delivered to each nozzle profile or different substances may be provided to each nozzle profiles in a similar manner to that described above relative to FIGS. 4a-4b. Multiple short nozzles in a nozzle assembly 14 can provide desired powder deposition similar to that of a single, long nozzle.

Referring to FIG. 5, a profile plate 30″ provides a nozzle profile 41″. The carrier gas is delivered to the nozzle profile 41″ using a gas inlet manifold 58 (connected to a carrier gas hole 39) that is in communication with the carrier gas inlet 46 of each nozzle profile 41″. In the example shown, a powder injection channel 60 separates each of the nozzle profiles 41″. A central, separate powder injection channel 60 enables uniform powder injection while minimizing the likelihood that the powder will impact the diverging portion walls. The powder injection channel 60 terminates in an exit 62 prior to intermingling with the carrier gas. The powder injection channel 60 includes an expansion area 64 that receives the powder. The carrier gas provided to the carrier gas inlet 46 accelerates through the throats 42 before intermingling with the powder. The nozzle profiles 41″ are defined, in part, by spaced apart walls 65 that enable the intermixed carrier gas and powder to develop a laminar flow. The walls 65 provide an increasing width that extends axially from the exit of the powder injection channel 60 to the end of the profile plate 30″, which provides the opening 56.

Referring to FIG. 6, another profile plate 30′″ is shown. The profile plate 30′″ includes nozzle profile 41 arranged between nozzle profiles 41′″. Carrier gas is provided to each of the carrier gas inlets 46 of the nozzle profiles 41, 41′″. The nozzle profiles 41, 41′″ are separated by walls that terminate in ends 70. The walls also define an exit 68 of the nozzle profile 41. A mixing region 68 is provided downstream from the ends 70 at which the intermixed powder and carrier gas from each venturi commingle. This arrangement of nozzle profiles 41, 41′″ allows for complex combinations of gas type, gas mixing, gas and particle mixing and location of merging gas streams. The throats of the venturis are arranged in different axial positions to achieve different gas speeds. The arrangement can permit high velocity gas streams to mix with a slower gas stream that is laden with powder and commingle at a desired location.

The example nozzle profiles 41′, 41″, 41′″. provide a diverging portion that has a length that is substantially greater than its width, which results in a desired spray pattern that conserved carrier gas. This also enables relatively powder travel speeds permitting rapid build up of adhered powder onto the substrate.

Although example embodiments of this invention has been disclosed, a worker of ordinary skill in this art would recognize that certain modifications would come within the scope of this invention. For that reason, the following claims should be studied to determine the true scope and content of this invention.

1. A cold gas dynamic spray system comprising:
a powder feeder for providing metallic powder;
a carrier gas source for providing carrier gas; and
a nozzle assembly including multiple plates secured to one another, one of the plates providing a nozzle profile having a carrier gas inlet receiving the carrier gas and a powder injection region receiving the metallic powder.

2. The system according to claim 1, wherein the nozzle assembly provides another nozzle profile.

3. The system according to claim 2, comprising a second source providing a substance different than the powder feeder and carrier gas source, the second source in communication with the other nozzle profile.

4. The system according to claim 2, wherein the nozzle profile is provided on a profile plate, and the other nozzle is provided on another profile plate, the profile plates and multiple plates secured to one another.

5. The system according to claim 1, wherein at least one of the plates includes a coating.

6. The system according to claim 5, wherein the coating includes desired wear resistant and friction properties.

7. The system according to claim 1, wherein gaskets are arranged between the plates.

8. The system according to claim 1, wherein the nozzle profile is provided by a venturi that includes converging and diverging portions joined by a throat, the carrier gas inlet in communication with the converging portion upstream from the throat, and the powder injection region in communication with the diverging portion downstream from the throat.

9. The system according to claim 8, wherein the powder intermingles with the carrier gas and flows through the diverging portion unrestricted to an opening at an end of the nozzle assembly.

10. A nozzle assembly for use with a cold gas dynamic spray system, the nozzle assembly comprising:
a profile plate having an aperture providing a venturi, the venturi including converging and diverging portions joined by a throat, a carrier gas inlet in communication with the converging portion upstream from the throat, and a powder inlet in communication with the diverging portion downstream from the throat, the profile plate having an end, the aperture having walls defining an increasing width extending axially from a location where the powder and carrier gas intermix to the end for providing generally laminar flow.

11. The nozzle assembly according to claim 10, wherein the walls provide an unrestricted passage from a powder injection region to the end.

12. The nozzle assembly according to claim 10, wherein the profile plate includes a coating.

13. The nozzle assembly according to claim 10, wherein the profile plate is a heat-treated metal.

14. The nozzle assembly according to claim 10, wherein the profile plate includes multiple venturies arranged parallel to one another and sharing a common opening at the end of the nozzle assembly.

15. The nozzle assembly according to claim 10, wherein the diverging portion includes a length that is substantially greater than a width of the diverging portion.

16. The nozzle assembly according to claim 10, wherein the aperture provides a flow path from the carrier gas inlet to the end with a single throat along the flow path.

17. A method of using a nozzle assembly for a cold gas dynamic spray system, the method comprising the steps of:
a) providing multiple plates, one of the plates providing a first nozzle profile;
b) selecting another plate having a second nozzle profile; and
c) assembling the plates including at least one of the two plates having the first and second nozzle profiles to provide a nozzle assembly.

18. The method according to claim 17, wherein step a) includes providing the multiple plates secured to one another to provide the nozzle assembly, the nozzle assembly disassembled prior to performing step c) and the other plate in step b) replacing the one plate in step a) when performing step c).

19. The method according to claim 17, wherein steps a) and b) are performed to provide the nozzle assembly having the first and second nozzle profiles when performing step c).

20. The method according to claim 17, comprising the step of connecting a metallic powder feeder to at least one of the first and second nozzle profiles.
